(19) United States
(12) Patent Application Publication
(10) Pub. No.: US 2023/0111753 A1
(43) Pub. Date: Apr. 13, 2023

(54) AN ADJUVANT COMPOSITION AND THE AGRICULTURAL COMPOSITION COMPRISING THE SAME

(71) Applicant: RHODIA OPERATIONS, Lyon (FR)

(72) Inventors: Renato Monterosso, Doreen (AU); Zixun Zheng, Shanghai (CN); Zhichao Han, Shanghai (CN); Pingping Xu, Nantong (CN); Marc Balastre, Lyon (FR); Zixian Chen, (SG)

(73) Assignee: RHODIA OPERATIONS, Lyon (FR)

(21) Appl. No.: 17/788,200

(22) PCT Filed: Dec. 23, 2019
(86) PCT No.: PCT/CN2019/127501

§ 371 Date: Jun. 22, 2022

(51) Int. Cl. A01N 25/04; A01N 25/30; A01N 25/24

(52) U.S. Cl. CPC A01N 25/04; A01N 25/30; A01N 25/24

(57) ABSTRACT

The present application relates to an adjuvant concentrate composition comprising a liquid medium, a drift reduction agent, a non-ionic surfactant and water. The present application further comprise an agricultural concentration composition comprising the same and the preparation method thereof.

### FIELD OF THE INVENTION

The present application relates to an adjuvant concentrate composition comprising a liquid medium, a drift reduction agent, a non-ionic surfactant and water. The present application further relates to an agricultural concentration composition comprising the same and the preparation method thereof.

### BACKGROUND

Agricultural active ingredients like agricultural pesticides, including insecticides, fungicides, herbicides, miticides and plant growth regulators as well as tank-mix adjuvants or fertilizers are generally produced in pure or highly concentrated form. However, they are to be used on agricultural operation sites in low concentration. To this end, they are usually formulated with other ingredients that enable easy dilution by the farm operator. The dilution is generally performed by mixing the agricultural concentrated formulation with water.

Oil dispersions are type of compositions consisting in a suspension of active material(s) in an apolar medium, generally an oily fluid intended to be diluted with water before use. The document WO2013/043678 discloses some concentrate formulations that can be readily combined with pesticide to form an oil dispersion which subsequently may be diluted, in particular by a farm operator, with water to form the corresponding pesticide emulsion. This prior art formulations include at least one plant oils or alkyl ester thereof.

Plant oil (also its alkyl esters) or fatty acid esters, and guar gum are well known as good agricultural adjuvants which bring anti-drift functionality to tank-mix products. There are many technologies about use oil concentrate, or guar gum formulations to control the drift. However it is well known in the field that it is very challenging to formulate the two components in a stable single concentrate formulation. US 2018/0184647 disclose a drift control adjuvant formulation comprising a seed oil and guar gum, however it is a diluted formulation rather than a concentrate one.

Therefore it is desirable to develop a stable adjuvant concentrate formulation which combine the use of plant oil and polysaccharide so as to provide better drift control.

### SUMMARY OF THE INVENTION

In one aspect of the present disclosure, it is provided a stable adjuvant concentrate formulation which comprise high concentration of oil and guar gum in a homogeneous form. The formulation is sable both at ambient and high temperature during storage without any separation, gelling, sedimentation or significant viscosity increase, moreover the formulation has better drift control performance than either high concentration of oil or guar gum.

The adjuvant concentrate composition as provided in the present disclosure comprises:
a) a liquid medium wholly or partly formed from plant oils or alkyl esters thereof, fatty acid alkyl esters and mixtures thereof, having an amount of 30% to 80% by weight, based on 100% by weight of the adjuvant concentrate composition;
b) a guar gum having an amount of 3.5% to 30% by weight, based on 100% by weight of the adjuvant concentrate composition;
c) a non-ionic surfactant selected from sorbitol alkoxylates, castor oil alkoxylates, fatty alcohol alkoxylates, fatty acid alkoxylates and the mixture thereof, having an amount of 5% to 30% by weight, preferably 5% to 20% by weight, based on 100% by weight of the adjuvant concentrate composition; and
d) water having an amount of 2% to 30% by weight, based on 100% by weight of the adjuvant concentrate composition.

In another aspect of the present disclosure, it is provided an agricultural concentration composition, comprising:
a) pesticide active component; and
b) the adjuvant concentrate composition as illustrated above;

wherein the pesticide active component has an amount of 0.5% to 30% by weight, based on the total weight of the agricultural concentration composition.

In still another aspect of the present disclosure, it is provided a method of preparing an agricultural concentration composition comprising a step of mixing the components comprising
a) pesticide active component; and
b) the adjuvant concentrate composition according to any one of claims 1 to 9.

wherein the pesticide active component a) has an amount of 0.5% to 30% by weight, based on the total weight of the agricultural concentration composition.

### DETAILED DESCRIPTION OF INVENTION

Adjuvant Concentrate Composition

As above mentioned, in one aspect of the present disclosure, it is provided an adjuvant concentrate composition comprising:
a) a liquid medium wholly or partly formed from plant oils or alkyl esters thereof, fatty acid alkyl esters and mixtures thereof, having an amount of 30% to 80% by weight, based on 100% by weight of the adjuvant concentrate composition;
b) a guar gum having an amount of 3.5% to 30% by weight, based on 100% by weight of the adjuvant concentrate composition;
c) a non-ionic surfactant selected from sorbitol alkoxylates, castor oil alkoxylates, fatty alcohol alkoxylates, fatty acid alkoxylates and the mixture thereof, having an amount of 5% to 30% by weight, preferably 5% to 20% by weight, based on 100% by weight of the adjuvant concentrate composition; and
d) water having an amount of 2% to 30% by weight, based on 100% by weight of the adjuvant concentrate composition.

In one embodiment of the present disclosure, 5% aqueous solution of the adjuvant concentrate composition has a pH of 3.0 to 7.0, preferably 3.0 to 5.5.

The adjuvant concentrate composition are pourable. In particular, the adjuvant concentrate composition have a viscosity of 200 to 3000 mPa·s.

The viscosity of the adjuvant concentrate composition may be measured on a Brookfield DV2T viscometer with a LV-3 spindle at a rotational speed of 20 rotations per minute (rpm), 25° C.

The adjuvant concentrate composition according to the present disclosure is a concentrate composition, and will be diluted by water more than 50 times, up to 200 times prior being applied to farm filed.

Moreover, the adjuvant concentrate composition according to the present disclosure show a good storage stability, are emulsifiable and provide stable emulsions when diluted into water.

Liquid Medium

The liquid medium of the adjuvant concentrate composition according to the present disclosure comprises or consists in plant oil or alkyl esters thereof, fatty acid alkyl ester or mixtures thereof.

For the purpose of the present disclosure, “liquid medium” means a medium that is in the liquid phase at room temperature and atmospheric pressure.

According to a first embodiment, the liquid medium is wholly formed from at least one plant oil or alkyl esters thereof, fatty acid ester or mixtures thereof.

According to a second embodiment, the liquid medium is partly formed from at least one plant oil or alkyl esters thereof, fatty acid alkyl ester or mixtures thereof. The liquid medium thus may comprise other solvents and in particular aromatic solvents such as for example the Solvesso™ solvents commercialized by ExxonMobil Chemical.

The plant oils, as used herein, means any single natural, non-petroleum, non-synthetic oil derived from a plant, vegetable or fruit or shrub or flower or tree nut, or any combination of natural, non-petroleum, non-synthetic oils derived from a plant, vegetable or fruit or shrub or tree nut.

The plant oils according to the present disclosure can be selected from soybean oil, rapeseed oil, corn seed oil, sunflower oil, cotton seed oil, linseed oil, coconut oil, palm oil, safflower oil, walnut oil, peanut oil, olive oil or castor oil and mixtures thereof.

As plant oil alkyl esters particularly convenient for the disclosure, the methylated plant oil esters may be cited like for example rapeseed oil methyl ester, soybean oil methyl ester or corn oil methyl ester.

The fatty acid alkyl esters according to the present disclosure can be selected from alkyl esters of C₁₀-C₂₂ alkyl, preferably C₁₂-C₂₀ fatty acids. The C₁₀-C₂₂ fatty acid alkyl esters can be selected from alkyl esters of unsaturated or saturated C₁₀-C₂₂ fatty acids, in particular with an even number of carbon atoms, for example but not limited to, erucic acid, lauric acid, palmitic acid. In one preferable embodiment, fatty acid alkyl esters are selected from C₁₈ fatty acids alkyl ester such as stearic acid, oleic acid, linoleic acid or linolenic acid, in particular oleic acid. Methyl oleate is particular useful in the present disclosure.

For the purpose of the present disclosure, “alkyl” means a saturated straight chain or branched chain hydrocarbon radical, preferably having 1 to 6 carbon atoms, more preferably 1 to 4 carbon atoms, such as for example, methyl, ethyl, n-propyl, iso-propyl, n-butyl, sec-butyl, t-butyl, pentyl, n-hexyl.

The adjuvant concentrate composition according to the present disclosure may comprise liquid medium from 30% to 80% by weight, preferably 35 to 75% by weight of its total weight of the liquid medium.

Guar Gum

As generally used herein, i.e., in the absence of an explicit limitation such as “derivatized” or “native”, the term “guar gums” refers collectively to native guar gums and derivatized guar gums which both can be used in the present disclosure.

Native guar gum refers to the mucilage found in the seed of the leguminous plant Cyamopsis tetragonolobus. The water soluble fraction (85%) is called “guaran,” which consists of linear chains of (1,4)-β-D mannopyranosyl units-with α-D-galactopyranosyl units attached by (1,6) linkages. The ratio of D-galactose to D-mannose in guarana is about 1:2. Native guar gum typically has a weight average molecular weight of between 2,000,000 and 5,000,000 g/mol. Guars having a reduced molecular weight, such as for example, from about 50,000 to about 2,000,000 g/mol are also known.

Functionally, native guar gum is a cold water swelling, nonionic polysaccharide which develops and maintains its properties over a wide pH range. The guar polysaccharide is a complex carbohydrate polymer composed of essentially a straight chain of mannose units with single-membered galactose branches, chemically classified as a polygalactomannan.

The term “derivatized guar” is meant to derivatized guar prepared by, but not limited to, etherification or esterification reactions to native guar.

Etherification and esterification reactions are made on the guar hydroxyl functionalities. The C6 hydroxyl position is the most reactive position for etherification, for example, with propylene oxide, but the secondary hydroxyls are also probable sites.

Principle etherification reactions are carboxymethylation via monochloroacetic acid, hydroxyalkylation via ethylene oxide or propylene oxide, and quaternization with various quaternary amine compounds containing reactive epoxide or chloride sites. Anionic and cationic sites modify the way the guar molecule interacts with inorganic salts, hydrated cellulosic and mineral surfaces, and organic particulates.

In general, the hydroxyalkyl ethers of polygalactomannans are prepared by reacting the polygalactomannans with alkylene oxides under basic conditions. In U.S. Pat. Nos. 3,723,408 and 3,723,409, guar flour is reacted with alkylene oxides in the presence of water and sodium hydroxide. The reaction product is then neutralized with acid, washed with an alcohol-water mixture, and is then dried and ground. In U.S. Pat. No. 3,483,121, the polygalactomannans and the alkylene oxides are reacted under basic conditions with small amounts of water and larger amounts of water miscible or water immiscible organic solvents.

Specific hydroxyalkylating agents include ethylene oxide, propylene oxide-1,2; butylene oxide-1,2; hexylene oxide-1,2; ethylene chlorohydrin; propylene chlorohydrin; and epichlorohydrin.

Carboxyalkyl ethers and mixed carboxyhydroxyalkyl ethers of polygalactomannans are described in U.S. Pat. Nos. 3,740,388 and 3,723,409, respectively. These derivatives are made by reacting the polygalactomannan with the derivatizing agents (halofatty acid and alkylene oxide) in a water-alcohol mixture followed by washing with water-alcohol mixtures.

Specific carboxyalkylating agents include chloroacetic acid, chloropropronic acid, and acrylic acid.

Carboxymethylation introduces an anionic function to the polymer chain and further increases the solubility of guar.

Other derivatives of polygalactomannans are described in such patents as U.S. Pat. No. 2,461,502 (cyanoethyl ethers), U.S. Pat. No. 4,094,795 (dialkylacrylamide ethers) and U.S. Pat. No. 3,498,912 (quaternary ammonium alkyl ethers). In the described processes, the reactions are conducted in water-organic solvent mixtures and the reaction products are washed with solvents of water solvent mixtures. Specific quaternary ammonium alkylating agents are such agents as 2,3-epoxypropyl trimethylammonium chloride, 3-chloro-2-hydroxypropyl trimethylammonium chloride and the like.

Other agents that can react with the hydroxyl groups of the polygalactomannans to form ether groups are, for example, alkylating agents which include methyl chloride, methyl bromide, ethyl chloride, ethyl iodide and isopropyl chloride; aminoalkylating agents; such as aminoethyl chloride, aminopropyl bromide, and N,N-dimethyl-aminopropyl chloride; ethylenically unsaturated group containing agents which react through Michael addition with hydroxyl groups such as acrylamide, methacrylamide, acrylonitrile, methacrylonitrile, acrylic acid, sodium acrylate and, in fact, any of the polymerizable monomers which contain one ethylenically unsaturated polymerizable group.

In one embodiment of the present disclosure, the guar gum is selected from native guar, hydroxypropyl guar, carboxymethyl guar, hydroxypropyl trimethylammonium guar, hydroxypropyl lauryldimethylammonium guar or hydroxypropyl stearyldimethylammonium guar.

According to the present disclosure, the guar gum has an amount of 3.5% to 30% by weight, preferably 4% to 15% by weight, based on 100% by weight of the stable adjuvant concentrate composition.

Non-Ionic Surfactant

The adjuvant concentrate composition according to the present disclosure comprises a non-ionic surfactant (c) selected from sorbitol alkoxylates, castor oil alkoxylates fatty alcohol alkoxylates, fatty acid alkoxylates and the mixture thereof.

For the purpose of the present disclosure, “surfactant” means an amphiphilic compound that comprises a hydrophilic moiety and a hydrophobic moiety and that, when present in water, lowers the surface tension of the water.

Preferably, an adjuvant concentrate composition according to the present disclosure comprises at least one sorbitol alkoxylates, as non-ionic surfactant.

More particularly, the sorbitol alkoxylates may be chosen among sorbitan esters.

According to an advantageous embodiment, the sorbitol alkoxylates are chosen among ethoxylated sorbitan esters like for example the Alkamuls T/80 commercialized by Solvay and preferably the Alkamuls T85V commercialized by Solvay.

In one embodiment of the present disclosure, the non-ionic surfactant is selected from castor oil alkoxylates.

Suitable castor oil alkoxylates include, but not limited to, castor oil alkoxylated with from 2 or more moles of (C₂-C₄) alkylene oxide units per molecule, as well as alkyl esters of thereof. Suitable alkoxylated castor oils include, for example, polyethoxylated castor oils, polypropoxylated castor oils, and polyethoxylated-propoxylated castor oils, ethoxylated castor oil oleate, and ethoxylated castor oil trilaurate.

Suitable fatty alcohol alkoxylates can be made by reacting alkylene oxides with alcohols including linear or branched, saturated or unsaturated (C₆-C₂₂), more typically (C₁₀-C₂₂), alcohols, such as, for example, lauryl alcohol, tridecyl alcohol, cetyl alcohol, stearyl alcohol, and oleyl alcohol. Fatty alcohol ethoxylates is preferred in the present disclosure, which are ethoxylated with, for example, from 1 to 50, more typically 2 to 50, oxyethylene units per molecule, such as, for example, ethoxylated lauryl alcohol, ethoxylated cetyl alcohol, ethoxylated tridecyl alcohol, ethoxylated stearyl alcohol, and ethoxylated oleyl alcohol.

Suitable fatty acid alkoxylates can be made by alkylene oxides with fatty acids. According to one embodiment of the present disclosure, the fatty acid alkoxylates is ethoxylates which may be chosen among polyethylene glycol derivatives, and more preferably among polyethylene glycol esters such as Alkamuls AP, Alkamuls A and Alkamuls VO2003 that are commercialized by Solvay.

The adjuvant concentrate composition according to the present disclosure may comprise non-ionic surfactant from of 5% to 30% by weight, preferably 5% to 20% by weight, based on 100% by weight of the adjuvant concentrate composition.

Water

The adjuvant concentrate composition according to the present disclosure comprises water of 2% to 30% by weight, based on 100% by weight of the adjuvant concentrate composition.

Water content is determined by a standard Karl Fischer titration method, which can be determined by using METTLER TOLEDO V20S Volumetric KF Titrator.

Water comprised in the adjuvant concentrate composition either comes from those embedded in the raw materials or is extra added. It was surprisingly found that the water content shall be in the range of 2% to 30 wt % (based on the total weight of the adjuvant concentrate composition) in order to obtain a stable formulation.

Other Components

Except the above components described, the adjuvant concentrate composition according to the present disclosure may further comprises other components according to practical needs, such as, but not limited to, pH regulator, anionic surfactant, sulfosuccinate surfactant, phyllosilicate and optionally activator thereof, and the like.

pH Regulator

As used herein, a “pH regulator” is understood to mean a chemical compound which enables the pH to be adjusted to the expected value. For example, the pH regulating agent can increase the pH; this is the case with bases, such as NaOH. Alternatively, the pH regulating agent can reduce the pH; this is the case with acids.

According to the present disclosure, 5% aqueous solution of the adjuvant concentrate composition has a pH value of 3.0 to 7.0, preferably 3.0 to 5.5, thereof inorganic, organic acids or salts thereof may be added as pH regulator.

As the pH regulator, an inorganic or organic acid can be used as needed.

Suitable inorganic acids include, but not limited to, hydrochloric acid, nitric acid, sulfuric acid, hydrofluoric acid, phosphoric acid, boric acid, and oxalic acid.

Suitable organic acids include, but not limited to acetic acid, propionic acid, butanoic acid, fumaric acid, citric acid, tartaric acid, succinic acid, itaconic acid.

Suitable organic or inorganic acid salts include, but not limited to ammonium sulfate, ammonium chloride, monosodium phosphate, monopotassium phosphate, disodium phosphate, and dipotassium phosphate.

Those compounds may be used alone or in combination of two or more thereof.

In one preferable embodiment of the present disclosure, the pH regulator is selected from citric acid, acetic acid, sulfuric acid, hydrochloric acid, phosphoric acid, ammonium sulfate and the mixture thereof.

The pH regulator is used in an amount suitably selected so that the pH of 5% aqueous solution of the adjuvant concentrate composition becomes a value within that range. In one embodiment of the present disclosure, the pH regulator has an amount of 0.1% to 5% by weight, preferably 0.1% to 3% by weight, more preferably 0.1% to 2% by weight, based on 100% by weight of the adjuvant concentrate composition.

Anionic Surfactant

In one embodiment of the present disclosure, the adjuvant concentrate composition according to the present disclosure further comprises at least one anionic surfactant which is selected from C₁₀-C₁₄ alkyl benzene sulfonate.

Suitable C₁₀-C₁₄ alkyl benzene sulfonate surfactants include for example, calcium dodecylbenzene sulfonate, sodium octadecylphenyl sulfonate, isopropylamine dodecyl benzene sulfonate, sodium tridecyl benzene sulfonate and sodium dodecyl benzene sulfonate.

According to an advantageous embodiment, the adjuvant concentrate composition according to the present disclosure comprises at least one dodecylbenzenesulfonate like for example the Rhodacal 60BE commercialized by Solvay.

The adjuvant concentrate composition according to the present disclosure may comprise from 0.5% to 20% by weight, in particular from 0.5% to 10% by weight, for instance from 0.5% to 5% by weight of its total weight of anionic surfactant(s), based on the total weight of the adjuvant concentrate composition.

Sulfosuccinate Surfactant

In one embodiment of the present disclosure, the adjuvant concentrate composition further comprises C₄-C₁₈ alkyl sulfosuccinates, C₄-C₁₈ dialkyl diester sulfosuccinates or the combination thereof. The sulfosuccinate surfactant in the adjuvant concentrate composition according the present disclosure may be alkoxylated, particularly ethoxylated.

Suitable alkyl sulfosuccinate surfactants intends to mean mono-alkyl sulfosuccinate, including but not limited to, laureth sulfosuccinate.

Suitable dialkyl sulfosuccinate surfactants include, but not limited to, dioctyl sulfosuccinate, bistridecyl sulfosuccinate, dihexyl sulfosuccinate, and diisobutyl sulfosuccinate.

In the present disclosure, the sulfosuccinate surfactants may have an amount of 1% to 15% by weight, preferably 3% to 12% by weight, based on 100% by weight of the adjuvant concentrate composition,

Phyllosilicate

In one embodiment of the present disclosure, the adjuvant concentrate composition according to the present disclosure further comprises a thickener selected from phyllosilicate.

This component is present in a sufficient amount to act as a thickener i.e in an amount of 1% to 5%, based on based on 100% by weight of the adjuvant concentrate composition.

Examples of suitable phyllosilicates are synthetic clays, such as laponite, or naturally occurring clays, such as bentonite, hectorite and montmorillonite. Clays of this type are often chemically treated to render them compatible with the liquid medium in which they are to be incorporated. For example, bentonite clays for use in non-polar are often treated with fatty amines or fatty quaternary ammonium compounds and are commercially available under the name Bentone (Rheox Inc., New Jersey).

In one embodiment, the phyllosilicate comprises an inorganic, typically aluminosilicate or magnesium silicate, colloid-forming clay, typically a smectite (also known as montmorillonoid) clay. These clay materials can be described as expandable layered clays, wherein the term “expandable” as used herein in reference to such clay relates to the ability of the layered clay structure to be swollen, or expanded, on contact with water.

Smectites are three-layered clays. There are two distinct classes of smectite-type clays. In the first class of smectites, aluminum oxide is present in the silicate crystal lattice and the clays have a typical formula of Al₂(Si₂O₅)₂(OH)₂. In the second class of smectites, magnesium oxide is present in the silicate crystal lattice and the clays have a typical formula of Mg₃(Si₂O₅)(OH)₂. The range of the water of hydration in the above formulas can vary with the processing to which the clay has been subjected. This is immaterial to the use of the smectite clays in the present compositions in that the expandable characteristics of the hydrated clays are dictated by the silicate lattice structure. Furthermore, atomic substitution by iron and magnesium can occur within the crystal lattice of the smectites, while metal cations such as Na⁺, Ca²⁺, as well as H⁺, can be present in the water of hydration to provide electrical neutrality. Although the presence of iron in such clay material is preferably avoided to minimize chemical interaction between clay and optional composition components, such cation substitutions in general are immaterial to the use of the clays herein since the desirable physical properties of the clay are not substantially altered thereby.

The layered expandable aluminosilicate smectite clays useful herein are further characterized by a dioctahedral crystal lattice, whereas the expandable magnesium silicate smectite clays have a trioctahedral crystal lattice.

Suitable smectite clays, include, for example, montmorillonite (bentonite), volchonskoite, nontronite, beidellite, hectorite, saponite, sauconite and vermiculite, are commercially available.

As noted above, the clays employed in the adjuvant concentrate compositions of the present disclosure comprise cationic counter ions such as protons, sodium ions, potassium ions, calcium ions, magnesium ions and the like. It is customary to distinguish between clays on the basis of one cation which is predominately or exclusively absorbed. For example, a sodium clay is one in which the absorbed cation is predominately sodium. Such absorbed cations can become involved in exchange reactions with cations present in aqueous solutions.

Commercially obtained clay materials can comprise mixtures of the various discrete mineral entities. Such mixtures of the minerals are suitable for use in the present compositions. In addition, natural clays sometimes consist of particles in which unit layers of different types of clay minerals are stacked together (interstratification). Such clays are called mixed layer clays, and these materials are also suitable for use herein.

Preferably, the phyllosilicate is of the type of bentonite or derivative thereof like for example bentone 27V and bentone 34 that are commercialized by Elementis.

In one embodiment of the present disclosure, the adjuvant concentrate composition advantageously comprises from 1% to 10% and in particular from 1% to 3% by weight of phyllosilicate with respect to its total weight.

Regarding the activator of the phyllosilicate, it may be chosen among polar solvents. Polar solvents help to “wet” the clay and effect delamination thus facilitating the dispersion of the clay in the liquid medium. Examples of suitable clay activators are water, lower alkanols, such as methanol and ethanol, lower alkyl ketones such as acetone and methylethylketone and especially lower alkylene carbonates such as propylene carbonate.

In one embodiment, the phyllosilicate is the main, preferable the sole, thickening agent in the adjuvant concentrate composition of the present disclosure.

Naturally, an adjuvant concentrate composition according to the present disclosure may further comprise any additive usually contemplated in pesticide formulation like for example safeners or biocides.

An adjuvant concentrate composition according to the present disclosure may be obtained by adding, in the order listed, a fatty acid alkyl ester, a phyllosilicate as thickener, water, a guar gum and the surfactants according to the present disclosure to a homogenizer.

Applications

The adjuvant concentrate composition according to the present disclosure allow to achieve stabilized formulations with a great diversity of active materials, in particular active compounds used to control agricultural pests. However, these concentrate composition may also be convenient for vehiculing other active materials like fertilizers. These active materials and/or salts may be of very different chemical nature, like for example organic, inorganic, liposoluble or not.

The adjuvant concentrate composition according to the present disclosure is particularly interesting for industrial firms which, by using only one concentrate, may prepare a great diversity of pesticidal oil dispersions.

The adjuvant concentrate composition of the present disclosure are particularly convenient for the stable dispersion of solid active materials.

Therefore, it is provided in the present disclosure an agricultural concentration composition, comprising:

a) pesticide active component; and

b) the adjuvant concentrate composition as illustrated above;

wherein the pesticide active component has an amount of 0.5% to 30%, based on the total weight of the agricultural concentration composition.

As usual, this pesticidal oil dispersion may be wet-milled to reduce particle size of the pesticide active component.

The particles size of such a solid pesticide active component preferably is lower than 50 μm in particular lower than 20 μm and more particularly lower than 10 μm. This size may be measured by laser diffraction (CIPAC MT 187) or rough estimation of average diameter by optical microscopy.

Examples of suitable insoluble pesticide active component include, but not limited to is selected from herbicide, insecticide, fungicide, miticides, plant growth regulators and the combination thereof, more specifically, abamectin, azamethiphos, azoxystrobin, cyproconazole, bordeaux mixture, carbendazim, chlorsulfuron, copper hydroxide, copper oxide, copper oxychloride, cymoxanil, diflubenzuron, PMP, ethofumesate, DMP, lenacil, fenoxaprop-p-ethyl, iodosulfuron, florasulam, flutriafol, imidacloprid, imidacloprid, b-cyfluthrin, indoxacarb, iprodione, isoproturon, mancozeb, copper oxy, metamitron, nicosulfuron, mesotrione, rimsulfuron, thiacloprid, deltamethrin, thiobendazole, uniconazole, difenconazole, oxyfluorfen, quizalofop-p-ethyl, tebuconazole and their mixtures.

Later, when the farm operators want to use the agricultural concentration composition, they just have to dilute it into water to form an emulsion or suspoemulsion.

It has to be noticed that the agricultural concentration composition according to the present disclosure keep their storage stability even when supplemented with active materials.

This example also shows that these pesticidal oil dispersions are still pourable. At last, this example shows that the pesticidal oil dispersions according to the present disclosure are emulsifiable and provide stable emulsions when diluted into water

In one aspect of the present disclosure, it is provided a method of preparing an agricultural concentration composition comprising a step of mixing the components comprising
a) pesticide active component; and
b) the adjuvant concentrate composition as illustrated above;

wherein the pesticide active component has an amount of 0.5% to 30%, based on the total weight of the agricultural concentration composition.

In one embodiment of the present disclosure, the step of mixing is executed by mixing the pesticide active component a) together with at least one components of the adjuvant concentrate composition b), preferably by mixing the pesticide active component a) together with all the components of the adjuvant concentrate composition b).

In another embodiment of the present disclosure, the step of mixing is executed by mixing the pesticide active component a) and the pre-mixture of the adjuvant concentrate composition b), in other words, the adjuvant concentrate composition is mixed to form a pre-mixture, and then mixed with pesticide active component to provide the final product.

### EXAMPLES

Raw Material:

Alkamuls RC is an ethoxylated castor oil purchased from Solvay;

Aerosol OT-A ND is a dioctyl sulfosuccinate purchased from Solvay;

Alkamuls T/85-V is a polyoxyethylenated sorbitan ester from Solvay

Rhodacao 60/BE-C is a calcium alkyl benzene sulfonate from Solvay

BT-857 is an organic hydrophobically modified bentonite purchased from Zhejiang Tianlong;

AgRHO DR2000 is a guar gum powder from Solvay;

KATHON CG is preservative solution comprising 5-chloro-2-methyl-4-isothiazolin-3-one and 2-methyl-4-isothiazolin-3-one from Changzhou Ruihao;

### Example 1—the Adjuvant Concentrate Composition

The composition was made by adding, in the order listed and in the contents set forth in the Table 1 below, a methyl oleate, a polyoxyethylenated sorbitan ester, a ethoxylated castor oil, a calcium alkyl benzene sulfonate, a dioctyl sulfosuccinate (Aerosol OT-A ND from Solvay), water, citric acid, preservative, a thickener (organoclay: BT-857 provided by Zhejiang Tianlong) and a guar gum powder (AGRHO DR2000 from Solvay) to a blender.

Process:
Charge the methyl oleate, polyoxyethylenated sorbitan ester, ethoxylated castor oil, calcium alkyl benzene sulfonate, a dioctyl sulfosuccinate into blender and begin agitation;
Charge the citric acid, water, preservative into blender and stir;
charge the BT-857 into the blender and homogenizing it;
charge AgRHO DR2000 into the blender and homogenizing it;
continue homogenizing for another 10 minutes;

Each composition was diluted with DI water to 5% by weight, and then pH was determined pH meter.

Viscosity was measured with Brookfield DV2T viscometer using LV-3 spindle, with rotating speed of 20 rpm at 25° C.

Water content is determined by a standard Karl Fischer titration method using METTLER TOLEDO V20S Volumetric KF Titrator.

TABLE 1
the adjuvant concentrate composition

| Sample (by weight) | CS1 | CS2 | S3 | S4 | S5 | S6 |
|---|---|---|---|---|---|---|
| Methyl oleate (%) | 74.25 | 73.25 | 72.25 | 64.25 | 59.25 | 54.25 |
| Alkamuls T/85-V (%) | 6 | 6 | 6 | 6 | 6 | 6 |
| Rhodacao | 1.5 | 1.5 | 1.5 | 1.5 | 1.5 | 1.5 |
| 60/BE-C (%) | | | | | | |
| ALKAMULS RC (%) | 7.5 | 7.5 | 7.5 | 7.5 | 7.5 | 7.5 |
| AEROSOL | 4 | 4 | 4 | 4 | 4 | 4 |
| OT-A-ND (%) | | | | | | |
| Water (%) | 0.667 | 1.701 | 2.659 | 10.613 | 15.762 | 20.785 |
| Citric acid (%) | 0.75 | 0.75 | 0.75 | 0.75 | 0.75 | 0.75 |
| Kathon CG (%) | 0.25 | 0.25 | 0.25 | 0.25 | 0.25 | 0.25 |
| BT-857 (%) | 1.75 | 1.75 | 1.75 | 1.75 | 1.75 | 1.75 |
| AGRHO DR2000 (%) | 4 | 4 | 4 | 4 | 4 | 4 |
| pH of 5% aqueous | 3.46 | 3.55 | 3.48 | 3.51 | 3.40 | 3.45 |
| solution | | | | | | |
| Initial viscosity | 32 | 162 | 181 | 132 | 284 | 256 |
| (mPa · s) | | | | | | |
| Viscosity after 2 | oil separation | 1566 | 1388 | 1225 | 1026 | 588 |
| weeks 54° C. storage | and solid | | | | | |
| (mPa · s) | sediment | | | | | |
| Top oil separation r.t. | oil separation | 8% | 5% | 5% | <1% | <1% |
| (2 week) | and solid | | | | | |
| | sediment | | | | | |
| Top oil separation | oil separation | 25% | 15% | 10% | <1% | <1% |
| 54° C. (2 week) | and solid | | | | | |
| | sediment | | | | | |

From the viscosity and appearance measured after 2 weeks storage at 54° C., it clearly demonstrated that suitable amount water added into the formulation provided a much better stability than without. The formulation with more than 1% of water has better stability and lower viscosity than the control sample which was failed, though the top oil separation is still significant. By increase the water content to more than 10%, the oil separation decreased obviously.

### Example 2—the Composition Comprising Citric Acid as pH Regulator

A composition without citric acid was prepared according to the process as illustrated in Example 1.

TABLE 2
the effect of pH regulator

| Sample | S5 | S7 |
|---|---|---|
| Methyl oleate0290 (%) | 59.25 | 60 |
| Alkamuls T/85-V (%) | 6 | 6 |
| Rhodacao 60/BE-C (%) | 1.5 | 1.5 |
| ALKAMULS RC (%) | 7.5 | 7.5 |
| AEROSOL OT-A-ND (%) | 4 | 4 |
| Water (%) | 15.7 | 15.6 |
| Citric acid (%) | 0.75 | 0 |
| Kathon CG (%) | 0.25 | 0.25 |
| BT-857 (%) | 1.75 | 1.75 |
| AGRHO DR2000 (%) | 4 | 4 |
| pH of 5% aqueous solution | 3.40 | 6.00 |
| Initial viscosity (mPa · s) | 284 | 242 |
| Viscosity after 2 weeks 54° C. storage | 1026 | 894 |
| (mPa · s) | | |
| Top oil separation r.t. (2 week) | <1% | <1% |
| Top oil separation 54° C. (2 week) | <1% | <1% |
| Dilution (x100, 30 min, | Trace | 0.5 ml |
| 342 ppm water) | sedimentation | |

Regulating pH of the formulation to 3.40 by adding citric acid can help to improve the dilution stability of the composition in water, preventing guar gum sedimentation at the bottom of the container.

1. An adjuvant concentrate composition, comprising:
a) a liquid medium wholly or partly formed from plant oils or alkyl esters thereof, fatty acid alkyl esters and mixtures thereof, having an amount of 30% to 80% by weight, based on 100% by weight of the adjuvant concentrate composition;
b) a guar gum having an amount of 3.5% to 30% by weight, based on 100% by weight of the adjuvant concentrate composition;
c) a non-ionic surfactant selected from sorbitol alkoxylates, castor oil alkoxylates, fatty alcohol alkoxylates, fatty acid alkoxylates and the mixture thereof, having an amount of 5% to 30% by weight, based on 100% by weight of the adjuvant concentrate composition; and
d) water having an amount of 2% to 30% by weight, based on 100% by weight of the adjuvant concentrate composition.

2. The adjuvant concentrate composition according to claim 1, wherein the guar gum is selected from native guar, hydroxypropyl guar, carboxymethyl guar, hydroxypropyl trimethylammonium guar, hydroxypropyl lauryldimethylammonium guar or hydroxypropyl stearyldimethylammonium guar.

3. The adjuvant concentrate composition according to claim 1, wherein the composition further comprises anionic surfactant selected from C₁₀-C₁₄ alkyl benzene sulfonate.

4. The adjuvant concentrate composition according to claim 1 to 3, wherein the composition further comprises C₄-C₁₈ alkyl sulfosuccinates, or C₄-C₁₈ dialkyl diester sulfosuccinates or a combination thereof.

5. The adjuvant concentrate composition according to claim 1, wherein the composition further comprise a thickener selected from phyllosilicate.

6. The adjuvant concentrate composition according to claim 5, wherein the composition further comprises activator of phyllosilicate.

7. The adjuvant concentrate composition according to claim 1, wherein the adjuvant concentrate composition further comprises a pH regulator in an amount sufficient to regulate pH value of 5% aqueous solution of the adjuvant concentrate composition to a range of 3.0 to 7.0.

8. The adjuvant concentrate composition according to claim 7, wherein the pH regulator is selected from the group consisting of citric acid, acetic acid, sulfuric acid, hydrochloric acid, phosphoric acid, ammonium sulfate, ammonium chloride, monosodium phosphate, monopotassium phosphate, disodium phosphate, and dipotassium phosphate and the mixture thereof.

9. The adjuvant concentrate composition according to claim 1, wherein the adjuvant concentrate composition has a viscosity of 200 to 3000 mPa·s.

10. An agricultural concentration composition, comprising:
a) pesticide active component; and
b) the adjuvant concentrate composition according to claim 1;
wherein the pesticide active component has an amount of 0.5% to 30% by weight, based on total weight of the agricultural concentration composition.

11. The agricultural concentration composition according to claim 10, wherein the pesticide active component is selected from the group consisting of herbicide, insecticide, fungicide, miticides, plant growth regulators and a combination thereof.

12. A method of preparing an agricultural concentration composition comprising a step of mixing the components comprising
a) pesticide active component; and
b) the adjuvant concentrate composition according to claim 1.
wherein the pesticide active component a) has an amount of 0.5% to 30% by weight, based on the total weight of the agricultural concentration composition.

13. The method of preparing an agricultural concentration composition according to claim 12, wherein the step of mixing is executed by mixing the pesticide active component a) together with at least one components of the adjuvant concentrate composition b).

14. The method of preparing an agricultural concentration composition according to claim 12, wherein the step of mixing is executed by mixing the pesticide active component a) with the pre-mixture of the adjuvant concentrate composition b).

15. The method of preparing an agricultural concentration composition according to claim 12, wherein the step of mixing is executed by mixing the pesticide active component a) together with all the components of the adjuvant concentrate composition b).
